(19) United States
(12) Patent Application Publication
(10) Pub. No.: US 2013/0047193 A1
(43) Pub. Date: Feb. 21, 2013

(54) Systems and Methods of Providing Broadband Services with Dynamic Resource Allocation

(71) Applicant: Jeff Finkelstein, Alpharetta, GA (US)

(72) Inventor: Jeff Finkelstein, Alpharetta, GA (US)

(73) Assignee: COX COMMUNICATIONS, INC., Atlanta, GA (US)

(21) Appl. No.: 13/210,369

(22) Filed: Aug. 15, 2011

(51) Int. Cl. H04N 7/173

(52) U.S. Cl. 725/110

(57) ABSTRACT

Systems and methods for providing broadband services having dynamic resource allocation are described herein. Example embodiments of the systems involve communication of information between one or more of content provider server(s), a backbone data communication network, a telecommunication service provider broadband distribution network, and one or more subscriber interface device(s) that allocate resources upon request in connection with the delivery of a broadband service. Each device along a data communication path between a service requesting subscriber interface device and content provider server may be enabled for and uses the Resource Reservation Protocol (RSVP). During operation, a subscriber interface device (including a set top box or cable modem) may communicate an RSVP reservation message to the content provider server via the path causing various devices along the path to dynamically reserve resources (including, without limitation, bandwidth) and set priority information based upon the requirements for and characteristics of a data flow(s) needed for delivery of the broadband service.

### TECHNICAL FIELD

The present disclosure is generally related to telecommunications and, more particularly, is related to broadband telecommunication services.

### BACKGROUND

Many of today's cable-based telecommunication service providers employ a broadband distribution network topology for the delivery of broadband network services (including, but not limited to, digital television, video-on-demand, high-speed data, and telephony services) that dates back to the early 1990s. In this topology, a master head end receives downstream broadband data from a backbone data communication network and communicates the broadband data to regional head ends/hubs, generally, over optical fiber cable. The master head end and regional head ends/hubs are often arranged in ring configuration commonly referred to as a transport or metro ring. At a regional head end/hub, the received downstream broadband data corresponding to network television programming is often combined with data corresponding to television programming for local public, educational, and/or governmental channels. The downstream broadband data is communicated, typically, via optical fiber cable to nodes arranged in a point-to-point or star topology.

At a node, the video-on-demand and high-speed data portions of the downstream broadband data are delivered to Cable Modem Termination Systems (CMTSs) which convert the video-on-demand and high-speed data into radio frequency (RF) signals that are output on coaxial cables to cable modems and set top boxes present at subscriber premises.

The broadband data is communicated in the form of broadband data packets over backbone data communication networks using the Multiprotocol Label Switching (MPLS) data communication mechanism. In accordance with this mechanism, each broadband data packet ingressing a backbone data communication network, perhaps, from a content provider, is labeled by a Label Edge Router (LER) as the broadband data packet ingresses the network. During communication along a Label Switched Path (LSP) between its points of ingress and egress, a broadband data packet may transit through many Label Switch Routers (LSRs) before egressing the data communication network through another Label Edge Router (LER). The egress Label Edge Router (LER) removes the remaining label from the broadband data packet and communicates the broadband data packet toward its ultimate destination using routing information (most likely, an Internet Protocol (IP) or Media Access Control (MAC) address) present in the broadband data packet. There are heretofore unaddressed needs with previous solutions related to allocating resources in broadband networks.

### SUMMARY

Example embodiments of the present disclosure provide systems of providing broadband services with dynamic resource allocation. Briefly described, in architecture, one example embodiment of the system, among others, can be implemented as follows: a set top box configured to request allocation of data communication resources in connection with establishment of a data communication path for delivery of content to said the top box from a content source, the requested allocation of data communication resources from a broadband distribution network communicatively connected to the set top box, the broadband distribution network configured to communicate the request upstream along the data communication path.

Embodiments of the present disclosure can also be viewed as providing methods for providing broadband services with dynamic resource allocation. In this regard, one embodiment of such a method, among others, can be broadly summarized by the following steps: generating a request at a set top box for data communication resources in connection with a data communication path through a broadband distribution network for delivery of content to the set top box from a content source; and communicating the request upstream toward the content source along the data communication path, the request resulting in allocation of data communication resources for the data communication path.

### BRIEF DESCRIPTION OF THE DRAWINGS

FIG. 1 is a block diagram of an example embodiment of a system for providing broadband services with dynamic resource allocation.

FIG. 2A is a flow diagram of an example embodiment of a providing broadband services with dynamic resource allocation.

FIG. 2B is a flow diagram of an example embodiment of a providing broadband services with dynamic resource allocation.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

As previously provided, the egress Label Edge Router (LER) removes the remaining label from the broadband data packet and communicates the broadband data packet toward its ultimate destination using routing information (most likely, an Internet Protocol (IP) or Media Access Control (MAC) address) present in the broadband data packet. When the remaining label is removed from a broadband data packet by an egress Label Edge Router (LER) at a master head end, the broadband data packet has no priority information present to govern its further communication to a cable modem or set top box. So, the broadband data packet must be relabeled manually at the Cable Modem Termination Systems (CMTSs) using the Data Over Cable Service Interface Specification (DOCSIS) for delivery to a cable modem or set top box. Additionally, because the broadband distribution network has no prior knowledge of the priority, burst characteristics, and average bandwidth needs of the broadband data packets comprising, for example, a video stream being delivered to a cable modem or set top box in connection with a broadband service, the broadband distribution network cannot appropriately and dynamically provision bandwidth for use in delivering the broadband service to the subscriber. As a consequence and in order to assure that all subscribers can receive quality broadband services without interruption or degradation, cable-based telecommunication service providers may compensate by making larger capital expenditures on infrastructure that may be used at certain times, but not used at other times.

Broadly described, the present disclosure includes example embodiments of systems and methods for providing broadband services with dynamic resource allocation. According to the example embodiment described herein, one or more content provider server(s), a backbone data communication network, a telecommunication service provider broadband distribution network, and one or more subscriber interface device(s) are configured to allocate resources (including, but not limited to, bandwidth) upon request in connection with the delivery of a broadband service. Such configuration includes, without limitation, each device along a data communication path between, and including, a service requesting subscriber interface device and a content provider server being enabled for and using the Resource Reservation Protocol (RSVP). During the system's operation in accordance with the example embodiment, a subscriber interface device (including, but not limited to, a set top box or cable modem) communicates an RSVP reservation message to a content provider server via the data communication path. As ingress and egress Label Edge Routers (LERs), various Label Switching Routers (LSRs), and other telecommunication devices along the data communication path receive and forward the RSVP reservation message, the devices dynamically allocate and reserve appropriate resources (including, without limitation, bandwidth) and set priority information based upon the requirements for and characteristics of a data flow(s) needed for delivery of the broadband service.

Advantageously, the system enables a telecommunication service provider to provide broadband services (comprising, without limitation, video-on-demand, high-speed data, and telephony services) to subscribers with network resources being allocated and used as needed. The system also provides end-to-end bandwidth management for data communication paths, allows bandwidth information to be used in admitting subscriber interface devices onto the system, and enables dynamic provisioning of bandwidth according to the needs of the flows of data being directed to subscriber interface devices. These capabilities enable the telecommunication service provider to utilize existing resources more efficiently and to minimize capital expenditures on infrastructure that may be used at certain times, but not used at other times.

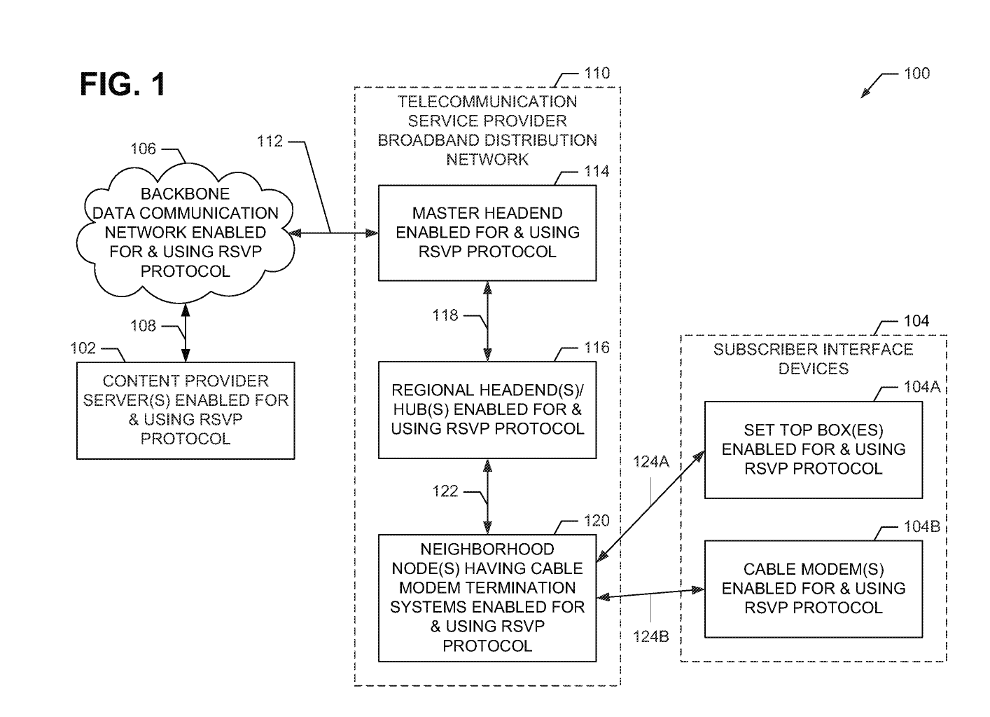

FIG. 1 displays a block diagram representation of system for providing broadband services 100 having resource bandwidth allocation in accordance with an example embodiment of the present disclosure. System for providing broadband services 100 (also referred to herein as “system 100”) is configured for delivering broadband data from content provider server 102 to subscriber interface devices 104 including, for example and not limitation, set top box 104A and cable modem 104B. The broadband data generally comprises a flow of data packets corresponding to and representative of a television program, movie, music video, commercial, advertisement, or other audio, video, or audiovisual content that is available and provided to subscribers of a telecommunication service provider through the service provider's video-on-demand or high-speed data broadband services.

Content provider server 102 comprises, according to the example embodiment, one or more server computer system(s) that are adapted to retrieve data representative of requested content from a data storage device or media that forms part of the server computer system(s), is co-located with the server computer system(s), or is accessible by communication link with the server computer system(s), and to communicate the data in the form of data packets to backbone data communication network 106 via bi-directional communication link 108. The server computer system(s) generally include one or more communication interfaces that communicate the data packets using the Resource Reservation Protocol (RSVP) (or the Resource Reservation Protocol with Traffic Engineering (RSVP-TE)) as a signaling or transport layer protocol and, perhaps, a version of the Internet Protocol (IP) as an Internet layer protocol. Each communication interface is adapted to receive data (perhaps, an Internet Protocol (IP) address or a Media Access Control (MAC) address) uniquely identifying requested content and set top box 104A or cable modem 104B to which the content is to be delivered and, in response, to generate and send an RSVP path message to set top box 104A or cable modem 1048, as the case may be, to establish a data communication path through the backbone data communication network 106 and the telecommunication service provider's broadband distribution network 110 to such set top box 104A or cable modem 1048.

Each communication interface is also adapted to periodically produce and communicate RSVP path messages along the established data communication path to set top box 104A or cable modem 1048 in order to refresh the path's reservation with routers and/or other communication equipment present along the established data communication path. Additionally, each communication interface is configured to receive an RSVP reservation message from the set top box 104A or cable modem 1048, as the case may be, providing a flowdescriptor having a flowspec and filterspec. The flowspec defines, for the content data flow over the established data communication path, the service class for the data flow, the reservation specification, which identifies the Quality of Service (QoS) for the data flow, and the traffic specification that describes the data flow. The filterspec defines, for the content data flow over the established data communication path, the set of data packets that are to be processed as described by the flowspec.

In accordance with the example embodiment, backbone data communication network 106 comprises a high-speed data communication network having Label Edge Routers (LERs), Label Switch Routers (LSRs), and/or other communication equipment adapted to process and bi-directionally communicate messages and flows of data packets using the Resource Reservation Protocol (RSVP) and the Multiprotocol Label Switching (MPLS) data communication mechanism. The Label Edge Routers (LERs) and Label Switch Routers (LSRs) are configured to use the Resource Reservation Protocol (RSVP) and the Multiprotocol Label Switching (MPLS) data communication mechanism to establish Label Switching Paths (LSPs), or MPLS tunnels, between ingress and egress Label Edge Routers (LERs), with one such Label Switching Path (LSP) forming part of the data communication path established by system 100 between content provider server 102 and set top box 104A or cable modem 1048 requesting content.

More particularly, upon receiving an RSVP reservation message being communicated to content provider server 102, the Label Edge Routers (LERs) and Label Switch Routers (LSRs) store information present in the flowdescriptor for the particular Label Switching Path (LSP), reserve the appropriate resources required to meet the requirements of the flowdescriptor, and communicate the received RSVP reservation message toward content provider server 102. Upon receiving an RSVP refresh message, the Label Edge Routers (LERs) and Label Switch Routers (LSRs) confirm the reservation of appropriate resources for the particular Label Switching Path (LSP) to which the RSVP refresh message applies.

System 100 further comprises a telecommunication service provider broadband distribution network 110 that, as illustrated in FIG. 1, is communicatively connected to the backbone data communication network 106 through appropriate communication links 112, including wired and/or wireless links such as, but not limited to, optical fiber links, coaxial cable links, and satellite links. Telecommunication service provider broadband distribution network 110 (also sometimes referred to herein as the “distribution network 110”) bi-directionally communicates messages and data packets between backbone data communication network 106 and subscriber interface devices 104 (described below).

At a more granular level, distribution network 110 includes master head end 114, one or more regional head end(s)/hub(s), and one or more neighborhood node(s) 120. Master head end 114 is communicatively connected via communication links 112 to a Label Edge Router (LER) of the backbone data communication network 106, and to each regional head end(s)/hub(s) 116 via appropriate communication links 118. The master head end 114 and each regional head end(s)/hub(s) 116 are, according to the example embodiment, enabled for and use the Resource Reservation Protocol (RSVP) to receive, appropriately direct, and communicate messages and flows of data packets corresponding to requested content. Each neighborhood node(s) 120 is communicatively connected to a respective regional head end/hub 116 through appropriate communication link 122 and, similar to master head end 114 and each regional head end(s)/hub(s) 116 and in accordance with an example embodiment, is enabled for and uses the Resource Reservation Protocol (RSVP) to receive, appropriately direct, and communicate messages and flows of data packets corresponding to requested content. More specifically, each neighborhood node 120 has one or more Cable Modem Termination Systems (CMTSs) that are Resource Reservation Protocol (RSVP) enabled or aware so that, unlike present Cable Modem Termination Systems (CMTSs), no relabeling of data packets is necessary for their appropriate direction and communication.

As briefly described above, system 100 still further comprises a plurality of subscriber interface devices 104, including set top boxes 104A and cable modems 1048 that are respectively and communicatively connected to a Cable Modem Termination System (CMTS) of neighborhood node 120 through appropriate communication link 124A, 124B. Typically, each set top box 104A is communicatively connected to a television set or similar device, and each cable modem 1048 is communicatively connected to a computer or similar device.

Each set top box 104A is generally adapted, similar to existing set top boxes, to receive data corresponding to digital television programming and to cause a connected television set to display such programming. Each set top box 104A is also generally adapted, similar to existing set top boxes, to cause a connected television set to present broadband service options such as, for example and not limitation, video-on-demand to a subscriber along with information identifying content available for selection and viewing by the subscriber. However, according to an example embodiment, each set top box 104A is enabled for and uses the Resource Reservation Protocol (RSVP) to communicate messages and data packets upstream indicating that the subscriber desires to use a broadband service offering. For example, such messages might indicate that the subscriber desires to use the video-on-demand broadband service to view particular selected content. Each set top box 104A is additionally configured to receive RSVP path and refresh messages generated and sent by content provider server 102, and to produce and communicate RSVP reservation messages to content provider server 102 to cause the reservation of resources (including, but not limited to, bandwidth) along an established data communication path through backbone data communication network 106 and broadband distribution network 110 appropriate for the reliable and uninterrupted downstream communication of data packets corresponding to content. In addition, each set top box 104A is configured to receive data packets corresponding to content and to cause presentation of the content on a connected television set.

Each cable modem 104B is generally adapted, similar to existing cable modems, to bi-directionally communicate data packets using the Internet Protocol (IP) and to communicate data packets with a connected computer in order for a subscriber to utilize, via the computer, high-speed broadband data services provided by the telecommunication service provider. In accordance with the example embodiment, however, each cable modem 1048 is enabled for and uses the Resource Reservation Protocol (RSVP) to bi-directionally communicate messages and data packets. Thus, each cable modem 104B is configured to receive RSVP path and refresh messages generated and sent by, for example and not limitation, content provider server 102, and to produce and communicate RSVP reservation messages to content provider server 102 causing the reservation of resources (including, but not limited to, bandwidth) along an established data communication path through backbone data communication network 106 and broadband distribution network 110 appropriate for the reliable and uninterrupted downstream communication of data packets corresponding to content.

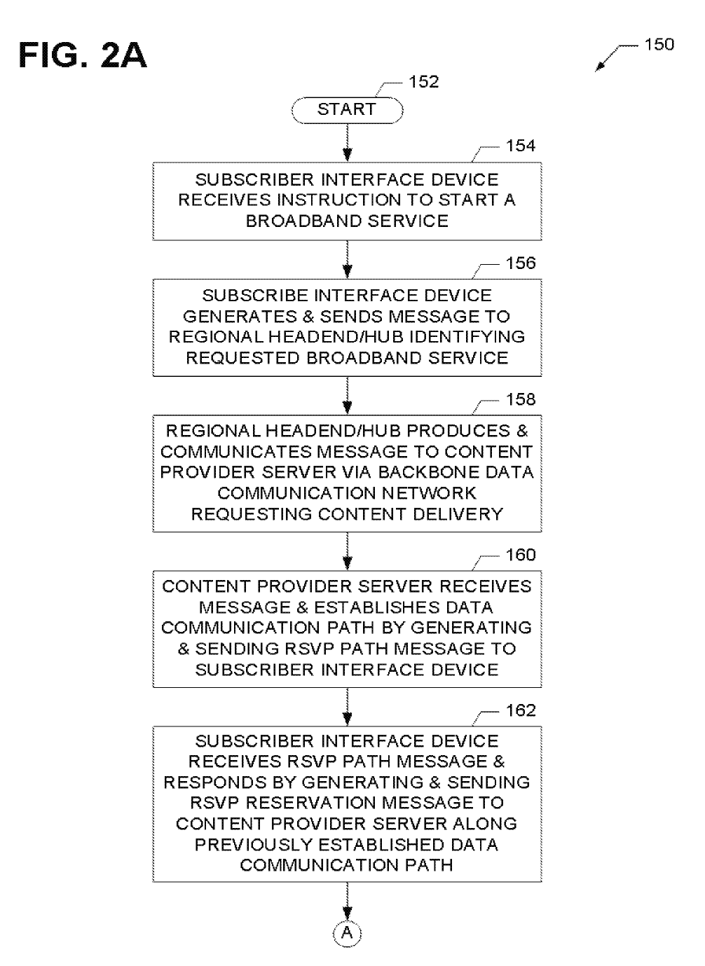

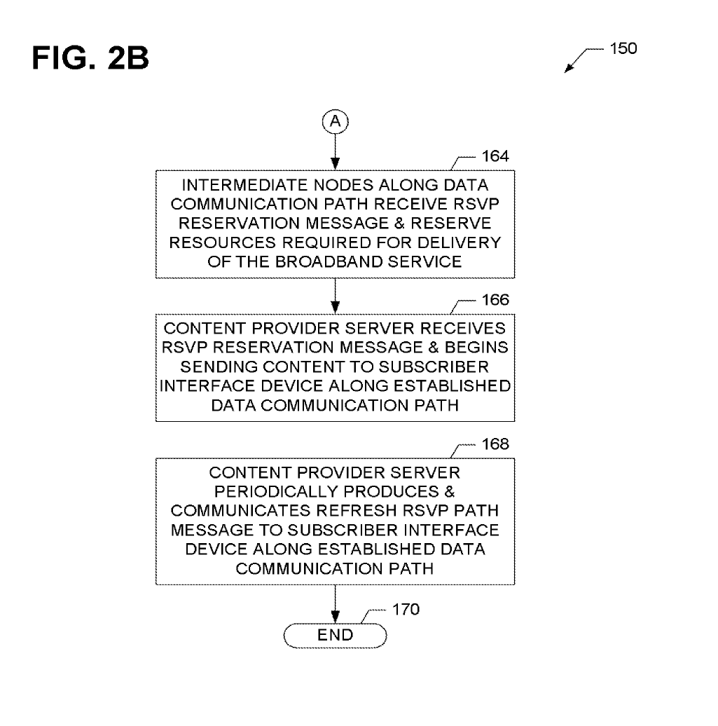

FIG. 2A and FIG. 2B display a flowchart representation of method 150 of operation of system 100 of FIG. 1, in accordance with an example embodiment, to provide a broadband service with dynamic resource allocation. After starting in block 152, method 150 advances to block 154 where subscriber interface device 104 receives direction from a subscriber of the telecommunication service provider to start a broadband service such as, for example and not limitation, a video-on-demand broadband service in which a flow of data packets corresponding to particular selected content is delivered to the subscriber interface device 104 from a content provider. In response in block 156, subscriber interface device 104 generates and sends an appropriate message to regional head end/hub 116 via neighborhood node 120 (and, hence, via a Cable Modem Termination System (CMTS) thereof) and communication links 122, 124 that service subscriber interface device 104. The message identifies the broadband service being requested by the subscriber and any content to be delivered to subscriber interface device 104 by content provider server 102.

Proceeding to block 158 of method 150 and responsive to receiving the message from subscriber interface device 104, regional head end/hub 116 identifies the appropriate content provider server 102 to provide the desired content, and then produces and communicates a message to an appropriate content provider server 102 through master head end 114, backbone data communication network 106, and communication links 108, 112, 118 to request playback of the desired content. In block 160, content provider server 102 receives the message from regional head end/hub 116 and establishes a data communication path by generating and sending an RSVP path message to subscriber interface device 104 requesting the broadband service. As the RSVP path message travels downstream toward subscriber interface device 104 through backbone data communication network 106, a Label Switching Path (LSP) is established between the ingress and egress Label Edge Routers (LERs) of backbone data communication network 106 to define and form part of the entire data communication path necessary for the download of a flow of data packets constituting the desired and requested content.

After the RSVP path message travels downstream through broadband distribution network 110, subscriber interface device 104 receives the RSVP path message in block 162 of method 150 and responds by producing and communicating an RSVP reservation message upstream to content provider server 102 through broadband distribution network 110 and backbone data communication network 106 along the data communication path previously established during communication of the RSVP path message. The RSVP reservation message includes a flowdescriptor appropriately identifying the bandwidth and other requirements and characteristics for the data communication path. As the ingress and egress Label Edge Routers (LERs), various Label Switching Routers (LSRs), and other telecommunication devices comprising intermediate nodes along the data communication path receive and forward the RSVP reservation message in block 164, they dynamically allocate and reserve appropriate bandwidth and set priority information for delivery of the flow of data packets corresponding to the desired content based on the flowdescriptor present in the RSVP reservation message.

In block 166 of method 150, content provider server 102 receives the RSVP reservation message and begins sending (and continues to send) the requested content as a flow of data packets along the previously established and reserved data communication path through backbone data communication network 106 and broadband distribution network 110 to subscriber interface device 104 that requested the content. During the delivery of the content and in block 168, content provider server 102 periodically produces and communicates an RSVP refresh message to subscriber interface device 104 using the data communication path. When the ingress and egress Label Edge Routers (LERs), various Label Switching Routers (LSRs), and other telecommunication devices along the data communication path receive and forward the RSVP refresh message, they confirm the reservation of appropriate resources for the data communication path. Once the delivery of the content is complete, content provider server 102 stops sending RSVP refresh messages, the Label Edge Routers (LERs), Label Switching Routers (LSRs), and other telecommunication devices along the data communication path release the bandwidth previously reserved for the flow of data packets, and operation in accordance with method 150 terminates in block 170.

The flow charts of FIGS. 2A and 2B show the architecture, functionality, and operation of a possible implementation of software for providing broadband services with dynamic resource allocation. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIG. 2A may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a non exhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Although the present disclosure has been described in detail, it should be understood that various changes, substitutions and alterations can be made thereto without departing from the spirit and scope of the disclosure as defined by the appended claims.

Therefore, at least the following is claimed:

1. A system comprising:
a set top box configured to request allocation of data communication resources in connection with establishment of a data communication path for delivery of content to said the top box from a content source, the requested allocation of data communication resources from a broadband distribution network communicatively connected to the set top box, the broadband distribution network configured to communicate the request upstream along the data communication path.

2. The system of claim 1, wherein the request is compliant with the Resource Reservation Protocol (RSVP) and the broadband distribution network is configured to operate according to the Resource Reservation Protocol (RSVP) for allocation of data communication resources.

3. The system of claim 1, wherein the request is compliant with the Resource Reservation Protocol (RSVP) and the set top box is configured to operate according to the Resource Reservation Protocol (RSVP).

4. The system of claim 1, wherein the broadband distribution network comprises a cable modem termination system communicatively connected to the set top box and is configured to receive the request for allocation of data communication resources from the set top box and to communicate the request upstream along the data communication path.

5. The system of claim 4, wherein the cable modem termination system is configured to operate according to the Resource Reservation Protocol (RSVP).

6. The system of claim 1, wherein the data communication path comprises a first data communication path, and wherein the system further comprises a cable modem configured to request allocation of data communication resources in connection with establishment of a second data communication path for delivery of content to the cable modem from a content source.

7. The system of claim 1, wherein the data communication resources comprises bandwidth of the broadband distribution network.

8. A method comprising:
generating a request at a set top box for data communication resources in connection with a data communication path through a broadband distribution network for delivery of content to the set top box from a content source; and
communicating the request upstream toward the content source along the data communication path, the request resulting in allocation of data communication resources for the data communication path.

9. The method of claim 8, wherein the request is compliant with the Resource Reservation Protocol (RSVP).

10. The method of claim 8, wherein the allocation includes allocation of bandwidth of the broadband data communication network based at least in part on data communication resource requirements of the request.

11. The method of claim 8, further comprising receiving admission for the set top box to the broadband distribution network based at least in part on data communication resource requirements of the request.

12. The method of claim 8, wherein the data communication path comprises a first data communication path, and wherein the method further comprises producing a request at a cable modem for data communication resources in connection with a second data communication path through the broadband distribution network for delivery of content to the cable modem from a content source.

13. The method of claim 12, wherein the request is compliant with the Resource Reservation Protocol (RSVP).

14. A system comprising:
a broadband distribution network communicatively connected to a set top box, configured to receive a request for allocation of data communication resources from the set top box and to communicate the request upstream along a data communication path, the request for allocation resulting from an establishment of the data communication path for delivery of content to the set top box from a content source.

15. The system of claim 14, wherein the request is compliant with the Resource Reservation Protocol (RSVP) and the broadband distribution network is configured to operate according to the Resource Reservation Protocol (RSVP) for allocation of data communication resources.

16. The system of claim 14, wherein the request is compliant with the Resource Reservation Protocol (RSVP) and the set top box is configured to operate according to the Resource Reservation Protocol (RSVP).

17. The system of claim 14, wherein the broadband distribution network comprises a cable modem termination system communicatively connected to the set top box and is configured to receive the request for allocation of data communication resources from the set top box and to communicate the request upstream along the data communication path.

18. The system of claim 14, wherein the data communication path comprises a first data communication path, and wherein the system further comprises a cable modem configured to request allocation of data communication resources in connection with establishment of a second data communication path for delivery of content to the cable modem from a content source.

19. The system of claim 15, further comprising:
a cable modem configured to generate a request for allocation of data communication resources along a data communication path to be used for the delivery of data packets corresponding to content communicated to the cable modem by a content source; and,
a cable modem termination system communicatively connected to the cable modem via the data communication path and adapted to receive the request for allocation of data communication resources from the cable modem and to communicate the request upstream along the data communication path.

20. The system of claim 19, wherein the cable modem termination system is configured to use the Resource Reservation Protocol (RSVP) when communicating with the cable modem.
